(19) United States
(12) Patent Application Publication
(10) Pub. No.: US 2024/0362558 A1
(43) Pub. Date: Oct. 31, 2024

(54) METHOD AND APPARATUS FOR DETERMINING RESTING PLACE OF VEHICLE

(71) Applicants: HYUNDAI MOTOR COMPANY, Seoul (KR); Kia Corporation, Seoul (KR)

(72) Inventors: Yoonsun KYE, Seoul (KR); Jeongjoon BOO, Seoul (KR); Jin woo LEE, Daejeon (KR); Younghyun JU, Yongin-si (KR); Geonu YU, Seoul (KR)

(73) Assignees: HYUNDAI MOTOR COMPANY, Seoul (KR); Kia Corporation, Seoul (KR)

(21) Appl. No.: 18/388,274

(22) Filed: Nov. 9, 2023

(30) Foreign Application Priority Data
Apr. 28, 2023 (KR) 10-2023-0056199

(51) Int. Cl. G06Q 10/0631; G06Q 10/02

(52) U.S. Cl. CPC G06Q 10/06315; G06Q 10/02

(57) ABSTRACT

A method for determining a resting place for a vehicle to be rested during a rest time predetermined by an operating server is provided. The method for determining a resting place of the vehicle includes, determining an allocation costs, for a plurality of resting places for a vehicle scheduled to be rested, by reflecting at least one of a moving distance to a resting place, expected demand information of the resting place, a driver's preference, whether there is a reservation call at the time of restarting driving after a rest time, and remaining driving time after the time of restarting the driving; and determining a target resting place of the vehicle scheduled to be rested based on the allocation costs for the plurality of resting places.

### CROSS-REFERENCE TO RELATED APPLICATION

The present application claims priority to Korean Patent Application No. 10-2023-0056199 filed on Apr. 28, 2023, the entire contents of which is incorporated herein for all purposes by this reference.

### BACKGROUND OF THE PRESENT DISCLOSURE

### Field of the Present Disclosure

The present disclosure relates to a method and apparatus for determining a resting place of a vehicle, and more particularly, to a method and apparatus for determining a resting place a resting place of a vehicle enabling efficient driving after a predetermined rest time.

### Description of Related Art

While drowsy driving by drivers has emerged as a social problem, sufficient rest time for drivers is guaranteed as a countermeasure to prevent it. For example, for the safety of the driver, a rest time of 15 minutes or more after the end of the driving is guaranteed if the driving time is 2 hours or more, and a rest time of 30 minutes or more after the end of the driving is guaranteed if the driving time is 4 hours or more.

In the present way, unlike the concept of temporarily stopping, the vehicle must be parked at a determined resting place during a rest time scheduled. The resting place where the vehicle should park is determined in advance, and the number of the resting place and location of the resting place may be determined according to the state of the service area.

In practice, the number of spots where the vehicle has to park is not large, and the locations may also be located at a considerable distance from the vehicle calling point.

If it is necessary to move a considerable distance to pick up a passenger to a vehicle call point when driving resumes after a predetermined rest time, the waiting time of the passenger may increase and the driving time and cost may increase due to the increase in vehicle driving distance.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method and apparatus for determining a resting place of a vehicle configured for reducing waiting time of passengers and increasing driving efficiency when driving is restarted after a predetermined rest time of a vehicle.

According to an exemplary embodiment of the present disclosure, a method for determining a resting place of a vehicle may be provided. The method for determining a resting place of a vehicle includes: determining an allocation costs, for a plurality of resting places for a vehicle scheduled to be rested, by reflecting at least one of a moving distance to a resting place, expected demand information of the resting place, a driver's preference, whether there is a reservation call at the time of restarting driving after a rest time, and remaining driving time after the time of restarting the driving; and determining a target resting place of the vehicle scheduled to be rested based on the allocation costs for the plurality of resting places.

The determining may include setting a first weight, a second weight, a third weight, a fourth weight, and a fifth weight applied to the moving distance to a resting place, the expected demand information of the resting place, the driver's preference, the whether there is the reservation call at the time of restarting driving after the rest time, and the remaining driving time after the time of restarting the driving, respective according to a length of a rest time of the vehicle scheduled to be rested.

The determining may further include converting the moving distance to a resting place, the expected demand information of the resting place, the driver's preference, the whether there is the reservation call at the time of restarting driving after the rest time, and the remaining driving time after the time of restarting the driving into values having a same unit.

The setting may include setting the first weight if the length of the rest time is shorter than a predetermined first reference time length to be greater than the first weight if the rest time is equal to or longer than the first reference time length.

The setting may include setting the second weight to be greater than the first weight if the length of the rest time is equal to or longer than a second reference time length set to be longer than the first reference time length.

The setting may further include setting the first weight equal to or greater than the second weight if the length of the rest time is shorter than the first reference time length.

The setting may include setting the first weight to 1 if the length of the rest time is shorter than a predetermined first reference time length.

The determining may include estimating expected demand information for each time slot for resting places of an entire service area with respect to the timing of restarting the driving of the vehicle scheduled to be rested; and obtaining expected demand information on the plurality of resting places in a service area of the vehicle scheduled to be rested from expected demand information by time slot on the resting places in the entire service area.

The method of determining the resting place of the vehicle may further include, if a target resting place of another vehicle scheduled to be rested whose rest time overlaps with the vehicle scheduled to be rested is the same as the target resting place of the vehicle scheduled to be rested, in a situation in which a resting place is not allocated within the service area or a resting has not started, changing the rest time of a vehicle scheduled to be rested, the rest time of which can be adjusted.

According to another exemplary embodiment of the present disclosure, an apparatus for determining a resting place of a vehicle may be provided. The apparatus for determining a resting place of a vehicle includes: a monitoring module for monitoring whether there is a vehicle scheduled to be rested for a rest time; and a resting place allocation module for determining a target resting place of the vehicle scheduled to be rested by use of a first factor indicating a moving distance from a location of the vehicle scheduled to be rested to each candidate resting place and a second factor representing expected demand information of each candidate resting place at a time of restarting driving of the vehicle scheduled to be rested after the rest time, if the rest time is equal to or longer than a predetermined first reference time

The apparatus for determining a resting place of a vehicle may further include a demand estimation module for estimating the expected demand information by time slot of the entire service area with respect to the timing of the restarting driving of the vehicle scheduled to be rested.

The resting place allocation module may set a first weight applied to the first factor and a second weight applied to the second factor.

The resting place allocation module may set the first weight equal to or greater than the second weight if a length of the rest time is shorter than the predetermined second reference time length, and set the second weight to be greater than the first weight if the length of rest time is longer than the second reference time length.

The resting place allocation module may set a service area for the vehicle scheduled to be rested, and extracts expected demand information of a plurality of candidate resting places within the service area from expected demand information of the entire service area.

The resting place allocation module may be configured to determine the target resting place further using a third factor representing driver's preference.

If there is a plurality of vehicles scheduled to be rested at the same determined target resting place, the resting place allocation module may maintain or change the target resting place determined for the plurality of vehicles scheduled to be rested based on whether there is a reservation call at the time of restarting driving after the rest time and remaining driving time after the time of restarting the driving.

The resting place allocation module may be configured to determine the target resting place of the vehicle scheduled to be rested using the first factor and the second factor if the length of the rest time is shorter than the first reference time length, and a weight applied to the first factor if the length of the rest time is shorter than the first reference time length, may be set higher than a weight applied to the first factor if the length of the rest time is greater than or equal to the first reference time length, or may be set to 1.

According to another exemplary embodiment of the present disclosure, a method for determining a resting place of a vehicle may be provided. The method for determining a resting place of a vehicle includes: deriving c number of arrangement combinations for allocating resting places b vehicles to be rested with overlapping rest times when a resting place is not allocated within a service area or a resting is not started for a number of resting places located in the service area; determining an allocation cost using an allocation cost function including a combination of at least two of a moving distance to the resting place, expected demand information of the resting place, driver's preference, whether there is a reservation call at a time of the restarting driving, and remaining driving time after the time of the restarting driving, for each of the c number of arrangement combinations; selecting one arrangement combination based on an allocation cost determined for each of the c arrangement combinations; and determining resting places of the b vehicles scheduled to be rested according to the selected arrangement combination.

The determining may include: converting the moving distance between the vehicle scheduled to be rested and the resting place constituting each arrangement combination into a value between 0 and 1; converting expected demand information of resting place constituting each arrangement combination into a value between 0 and 1; converting a driver's preference for a resting place constituting each arrangement combination into a value between 0 and 1; expressing as 0 or 1 whether there is a reservation call at a time of the restarting driving for the vehicle scheduled to be rested constituting each arrangement combination; and converting remaining driving time after the time of the restarting driving for the vehicle scheduled to be rested constituting each arrangement combination into a value between 0 and 1.

The allocation cost function may include a first weight, a second weight, a third weight, a fourth weight, and a fifth weight applied the moving distance to the resting place, the expected demand information of the resting place, the driver's preference, the whether there is a reservation call at a time of the restarting driving, and the remaining driving time after the time of the restarting driving, respective, and at least some of the first to fifth weights may be different from each other.

The first to fifth weights may be determined based on the length of the rest time.

The determining may include: in the selecting, if the same resting place is allocated to different vehicles scheduled to be rested by two or more arrangement combinations having the highest allocation cost, checking whether the rest time is adjusted from at least one vehicle scheduled to be rested; and changing a rest time of a vehicle scheduled to be rested for which the rest time can be adjusted.

The methods and apparatuses of the present disclosure have other features and advantages which will be apparent from or are set forth in more detail in the accompanying drawings, which are incorporated herein, and the following Detailed Description, which together serve to explain predetermined principles of the present disclosure.

### BRIEF DESCRIPTION OF THE DRAWINGS

FIG. 1 is a diagram a ridesharing service system according to an exemplary embodiment of the present disclosure.

FIG. 2 is a diagram illustrating an operation server according to an exemplary embodiment of the present disclosure.

FIG. 3 is a flowchart illustrating a method of determining a resting place according to a first resting place allocation method of the resting place allocation module shown in FIG. 2.

FIG. 4 is a flowchart illustrating a method of determining a resting place according to a second resting place allocation method of the resting place allocation module shown in FIG. 2.

FIG. 5 is a flowchart illustrating a method of setting a weight value applied to an allocation cost function according to an exemplary embodiment of the present disclosure.

FIG. 6 is a flowchart illustrating an example of a solution if target resting place of two or more vehicles scheduled to be rested overlap.

FIG. 7 is a flowchart illustrating another example of a solution if target resting place of two or more vehicles scheduled to be rested overlap.

FIG. 8 is a flowchart illustrating a method of determining a resting place of the resting place allocation module shown in FIG. 2 according to an exemplary embodiment of the present disclosure.

FIG. 9 is a diagram illustrating an apparatus for determining a vehicle resting place according to another exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various embodiments of the present disclosure will be described in detail with reference to the appended drawings so that a person of ordinary skill in the art may easily implement the present disclosure. As those skilled in the art would realize, the described embodiments may be modified in various different ways, all without departing from the spirit or scope of the present disclosure. The drawings and description are to be regarded as illustrative in nature and not restrictive. Like reference numerals designate like elements throughout the specification.

Throughout the specification and claims, when a part is referred to “include” a certain element, it means that it may further include other elements rather than exclude other elements, unless specifically indicated otherwise.

Furthermore, throughout the specification and claims, the suffixes “module”, “unit”, and/or “group” for components are assigned or used interchangeably in consideration of only the ease of writing the specification, and have meanings or roles that are distinguished from each other by themselves.

Also, in the present specification, terms such as “unit”, “group”, and “module” refer to a unit that processes at least one function or operation, and may be implemented as hardware or software or a combination of hardware and software.

In the present specification and claims, terms including an ordinal number, such as first, second, etc., may be used to describe various elements, but the elements are not limited by the terms. The above terms are used only for distinguishing one element from another element. For example, without departing from the scope of the present disclosure, a first element may be referred to as a second element, and similarly, a second element may be referred to as a first element.

Throughout the specification and claims, when an element is referred to as being “connected” to another element, it should be understood that it may be directly connected to the other element, but other elements in the middle between the element and another element may exist. On the other hand, when an element is referred to as “directly connected” to another element, it should be understood that no other element exists in the middle.

In the flowchart described with reference to the drawings in the present specification, the order of operations may be changed, several operations may be merged, some operations may be divided, and specific operations may not be performed.

Furthermore, in the present specification, each of the phrases such as “A or B”, “at least one of A and B”, “at least one of A or B”, “A, B, or C”, “at least one of A, B, and C”, and “at least one of A, B, or C” may include any one of the items listed together in the corresponding one of the phrases, or all possible combinations thereof.

Now, a method and apparatus for determining a vehicle resting place according to an exemplary embodiment of the present disclosure will be described in detail with reference to the drawings.

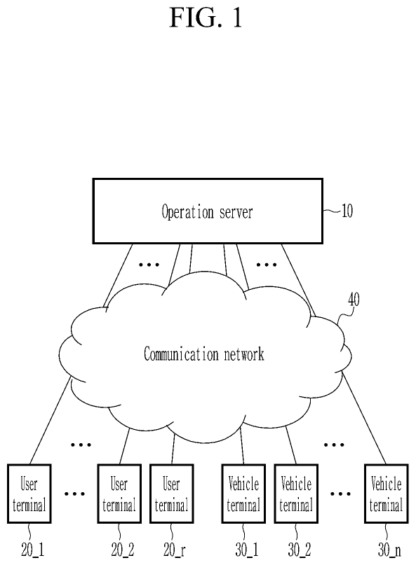

FIG. 1 is a diagram a ridesharing service system according to an exemplary embodiment of the present disclosure.

Referring to FIG. 1, the ridesharing service system 1 may include an operation server 10, user terminals 20_1 to 20_r, and vehicle terminals 30_1 to 30_n. Here, r and n are natural numbers greater than or equal to 1.

Vehicle terminals may be installed in all vehicles providing ridesharing services. FIG. 1 illustrates that n vehicles provide a ridesharing service and r user terminals request a vehicle call. Hereinafter, for convenience of description, when describing the features corresponding to all user terminals, the user terminal may be referred to by the reference numeral 20, and when the contents corresponding to all vehicle terminals are described, the vehicle terminal may be referred to by the reference numeral 30, while the reference numeral 20_j may be used to indicate a specific user terminal and the reference numeral 30_i may be used to indicate a specific vehicle terminal.

Transmission and reception of information between the user terminal 20 and the operation server 10 and transmission and reception of information between the vehicle terminal 30 and the operation server 10 may be performed through the communication network 40.

The user terminal 20 may transmit destination information and user location information received from a user who wants to use the ridesharing service to the operation server 10. The ridesharing service is a service that connects a vehicle and a driver with a rider. It may be a service in which people with the same destination ride in the same vehicle or it may be a service in which a vehicle or a ride is shared by renting a vehicle owned by the user to another person for a fee. The location information of the user may be information based on a location currently recognized using a global positioning system (GPS) of the user terminal 20. Alternatively, the location information of the user may be information based on a location directly input by the user to the user terminal 20.

The user terminal 20 may receive a vehicle call, a destination, and an origin from the user, and transmit the destination and origin along with notification of the vehicle call to the operation server 10. The origin may be the current location of the user terminal 20, and the current location may be recognized using Global Positioning System (GPS) of the user terminal 20. Furthermore, the user terminal 20 may transmit the number of passengers, etc. together with the starting point and destination to the operation server 10.

The user terminal 20 may receive information about a get-on place and a get-off place from the operation server 10. The user terminal 20 may receive information from the operation server 10, such as a vehicle identification number, a vehicle driver's contact information, an expected arrival time of the vehicle to the get-on place (hereinafter, an expected get-on time), an expected arrival time of the vehicle to the get-off place (hereinafter, an expected get-off time), etc., along with the get-on place and the get-off place.

The user terminal 20 may receive charging information about transportation service fares from the operation server 10 and pay the fares based on the charging information.

The user terminal 20 may be a smart phone, a laptop computer, a tablet PC, or the like, and an application for receiving a ridesharing service may be installed in the user terminal 20. The user terminal 20 may perform the aforementioned operations through an installed application.

The vehicle terminal 30 may be a terminal mounted on each of the vehicles providing the ridesharing service, and the vehicle terminal 30 may transmit the current location of the vehicle to the operation server 10 in real time, and receive information on the get-on places and the get-off places for passengers who will use the vehicle, and information on the expected get-on times for the get-on places and the expected get-off times for the get-off places from the operation server 10. The vehicle terminal 30 may also receive identification information on passengers who will use each vehicle from the operation server 10. The identification information on the passengers may be transmitted from the operation server 10 to the user terminal 20 of the passengers and the vehicle terminal 30 to be used by the passengers.

The vehicle terminal 30 may be a smart phone, a laptop computer, a tablet PC, or the like, and an application for providing a ridesharing service may be installed in the vehicle terminal 30. The vehicle terminal 30 may perform the aforementioned operations through an installed application.

The operation server 10 may receive information on a destination and an origin from the user terminal 20, and determine a vehicle to pass through the get-on place corresponding to the origin received from the user terminal 20 and the get-off place corresponding to the destination received from the user terminal 20 among vehicles configured for providing ridesharing services.

The operation server 10 may transmit the get-on place, the get-off place, an expected get-on time, an expected get-off time, and the identification information on the passenger, to the vehicle terminal of the determined vehicle 30_i and the user terminal 20_j requesting a vehicle call. Here, i may be one of natural numbers from 1 to n, and j may be one of natural numbers from 1 to r. Furthermore, the operation server 10 may further transmit a vehicle identification number, a vehicle driver's contact information, charging information, and the like to the user terminal 20_j.

The operation server 10 may allocate a target resting place in which the vehicle is to be parked to the vehicle scheduled to be rested from among a plurality of candidate resting places within the service area for the vehicle scheduled to be rested for a predetermined time period time period. The resting place may refer to a point where vehicle that does not operate according to the scheduled rest time will park. On the other hand, the stopping place may refer to a point where a vehicle that needs to stop for a while will park, such as a case that there is no call within driving time or the driver's circumstances. The resting place and the stopping place may overlap at least in part. That is, at least some of the stopping places may be set as resting places. Furthermore, at least some of the getting on or off stops may be set as resting places. Furthermore, a point for resting only, but not a stopping place or not a place getting on or off stops, may be set as a resting place. The rest time may be determined by the driving time of the vehicle or lunch time, and may be set to as short as several minutes or as long as several hours.

In determining the target resting place, the operation server 10 may reflect the rest time, the distance from the location of the vehicle scheduled to be rested to each resting place, and the expected demand at the time of restarting driving after the rest time of the vehicle scheduled to be rested within the service area.

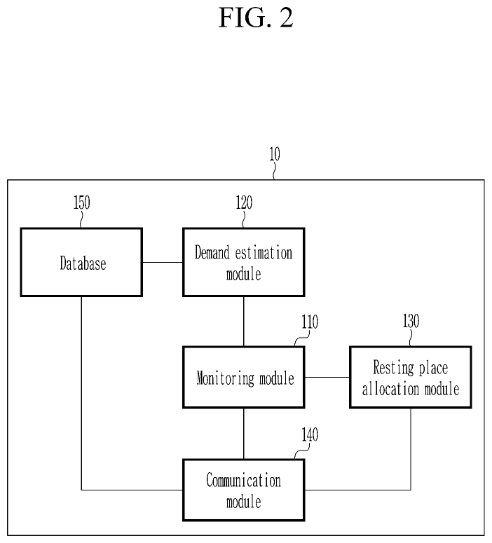

FIG. 2 is a diagram illustrating an operation server according to an exemplary embodiment of the present disclosure.

Referring to FIG. 2, the operation server 10 may include a monitoring module 110, a demand estimation module 120, a resting place allocation module 130, and a communication module 140. The operation server 10 may further include a database 150.

The monitoring module 110 may monitor whether there is a vehicle scheduled to be rested. The monitoring module 110 may receive a rest request signal from the vehicle terminal 30 through the communication module 140. The rest request signal may include information on the length of the rest time. The length of the rest time may be allocated for each vehicle terminal 30, in advance. The monitoring module 110 may be configured to determine whether a vehicle scheduled to be rested is generated based on whether the rest request signal is received. If a vehicle scheduled to be rested is generated during monitoring, the monitoring module 110 may transmit information on the vehicle scheduled to be rested to the resting place allocation module 130.

The demand estimation module 120 may estimate expected demand (e.g., the number of calls n, where n is a natural number greater than or equal to 1) for each time slot within the entire service area at the current time using service call data stored in the database 150. The demand estimation module 120 may estimate the expected demand for each time slot by sampling a predetermined number of data from call data for each time slot within the entire service area. The predetermined number may be a predetermined constant.

The resting place allocation module 130 may obtain location information of the vehicle to be rested through the communication module 140. The resting place allocation module 130 may obtain information on the length of the rest time of the vehicle scheduled to be rested through the monitoring module 110, and obtain expected demand information of the entire service area at the time of restart driving after the rest time of the vehicle scheduled to be rested through the demand estimation module 120.

The resting place allocation module 130 may allocate a target resting place to the vehicle scheduled to be rested using different resting place allocation methods according to the length of rest time of the vehicle scheduled to be rested.

If the length of the rest time is greater than or equal to the first reference time length, the resting place allocation module 130 may allocate a target resting place to a vehicle scheduled to be rested using a second resting place allocation method reflecting the moving distance from the location of the vehicle scheduled to be rested to the resting place and the expected demand at the time of restarting driving after the rest time. In the instant case, whether or not the last passenger of the vehicle scheduled to be rested may be considered. Furthermore, the second resting place allocation method may reflect other factors in addition to the moving distance from the location of the vehicle scheduled to be rested to the resting place and the expected demand at the time of restarting the driving.

As an exemplary embodiment of the present disclosure, the other factor may further include at least one of driver preference, whether or not a call is reserved at the time of restarting the driving, and remaining driving time after the restarting the driving. The remaining driving time may represent driving time remaining after the restarting the driving. That is, the remaining driving time may include the time from the time of restarting the driving to the time of the end of the driving.

If the length of the rest time is shorter than the first reference time length, the resting place allocation module 130 may allocate a target resting place to a vehicle scheduled to be rested using a first resting place allocation method in which the largest weight is applied to the moving distance from the location of the vehicle to be rested to the resting place.

As an exemplary embodiment of the present disclosure, in the first resting place allocation method, a weight applied to a moving distance may be set to 1. In the instant case, the target resting place may be allocated to the vehicle scheduled to be rested by reflecting only the moving distance from the location of the vehicle scheduled to be rested to the resting place. As another example, the first resting place allocation method may allocate a target resting place to a vehicle scheduled to be rested by considering the same factors as the second resting place allocation method, but in the first resting place allocation method, a weight applied to the moving distance from the location of the vehicle scheduled to be rested to the resting place may be set greater than that in the second resting place allocation method.

The communication module 140 may support wireless communication with the user terminal 20 and the vehicle terminal 30. The communication module 140 may receive a rest request signal requested from the vehicle terminal 30 and transmit it to the monitoring module 110. The communication module 140 may transmit the location information of the vehicle terminal 30 received from the vehicle terminal 30 to the resting place allocation module 130. Also, the communication module 140 may receive service call data requested from the user terminal 20 and transfer it to the database 150. Furthermore, the communication module 140 may transmit information on the target resting place allocated by the resting place allocation module 130 to the vehicle terminal of the vehicle to be rested.

The database 150 may store service call data requested from the user terminal 20.

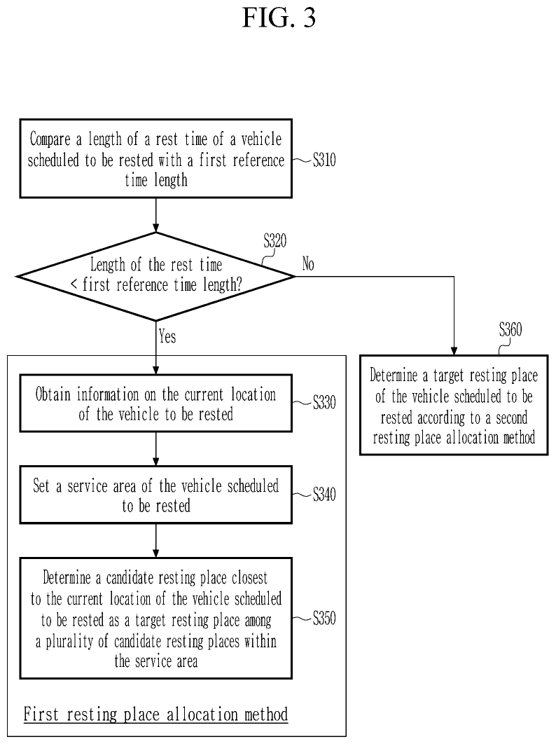

FIG. 3 is a flowchart illustrating a method of determining a resting place according to a first resting place allocation method of the resting place allocation module shown in FIG. 2.

Referring to FIG. 3, the resting place allocation module 130 may compare a length of rest time of a vehicle scheduled to be rested with a predetermined first reference time length (S310).

If the rest time length of the vehicle scheduled to be rested is shorter than the first reference time length (S320), the resting place allocation module 130 may be configured to determine the target resting place of the vehicle scheduled to be rested according to the resting place allocation method. For example, the first reference time length may be set to 20 minutes, or may be set different from that.

According to the first resting place allocation method, the resting place allocation module 130 may obtain information on the current location of the vehicle to be rested (S330).

The resting place allocation module 130 may set a service area of the vehicle scheduled to be rested having a predetermined range around the current location of the vehicle scheduled to be rested (S340).

The resting place allocation module 130 may be configured to determine a candidate resting place closest to the current location of the vehicle scheduled to be rested as a target resting place among a plurality of candidate resting places within the service area of the vehicle scheduled to be rested (S350). In FIG. 3, it is shown that the first resting place allocation method utilizes only the moving distance from the location of the vehicle to be rested to the resting place. That is, in the case of the first resting place allocation method, among the travel distance from the location of the vehicle to be rested to the resting place and expected demand at the time of restarting the driving, the weight applied to the moving distance may be set to 1 and the weight applied to the expected demand may be set to 0. The first resting place allocation method set in the instant way may be configured to determine a target resting place for a vehicle scheduled to be rested based on a moving distance from the location of the vehicle scheduled to be rested to each candidate resting place within the service area of the vehicle scheduled to be rested.

Meanwhile, if the rest time length of the vehicle scheduled to be rested is equal to or longer than the first reference time length (S320), the resting place allocation module 130 may be configured to determine the target resting place of the vehicle scheduled to be rested according to a second resting place allocation method (S360).

The resting place allocation module 130 may transmit information on the target resting place to the vehicle terminal of the vehicle scheduled to be rested through the communication module 140.

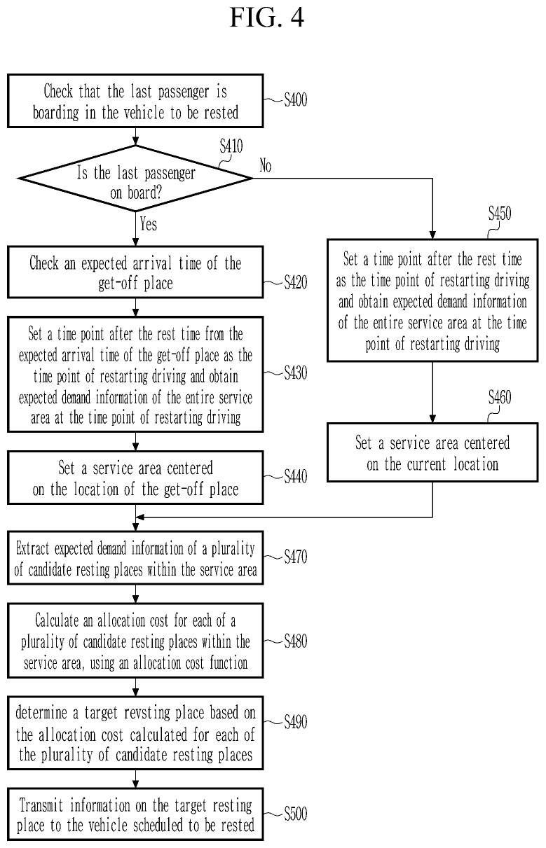

FIG. 4 is a flowchart illustrating a method of determining a resting place according to a second resting place allocation method of the resting place allocation module shown in FIG. 2.

Referring to FIG. 4, the resting place allocation module 130 may be configured to determine the target resting place of the vehicle scheduled to be rested according to the second resting place allocation method if the length of the rest time of the vehicle scheduled to be rested is equal to or longer than the first reference time length.

First, the resting place allocation module 130 may check that the last passenger is boarding in the vehicle to be rested (S400).

If the last passenger is boarding in the vehicle scheduled to be rested (S410), the resting place allocation module 130 may check an expected arrival time of the get-off place where the last passenger will get off (S420).

The resting place allocation module 130 may set a time point after the predetermined rest time from the expected arrival time of the get-off place as the time point of restarting driving the vehicle to be rested, and obtain expected demand information of the entire service area at the time point of restarting driving the vehicle to be rested (S430). The expected demand information of the entire service area at the time point of restarting driving may include expected demand information of a plurality of candidate resting places in the entire service area. The resting place allocation module 130 may request the expected demand information at the time point of restarting driving of the vehicle scheduled to be rested from the demand estimation module 120, and receive the expected demand information at the time point of restarting driving of the vehicle scheduled to be rested from the demand estimation module 120.

Next, the resting place allocation module 130 may set a service area for a vehicle to be rested having a predetermined range centered on the location of the get-off place where the last passenger gets off (S440).

On the other hand, if the passenger is not boarding (S410), the resting place allocation module 130 may set a time point after the rest time as the time point of restarting driving the vehicle to be rested, and obtain expected demand information of the entire service area at the time point of restarting driving the vehicle to be rested (S450), and set a service area for a vehicle to be rested having a predetermined range centered on the current location of the vehicle scheduled to be rested (S460).

That is, depending on whether or not the last passenger has boarded, the start time of the rest of the vehicle scheduled to be rested may be different, and the time point of restarting driving the vehicle to be rested after the rest time may be changed. Therefore, the resting place allocation module 130 may be configured to determine whether or not the last passenger is boarding, determine the time point of restarting driving of the vehicle scheduled to be rested according to whether or not the last passenger is boarding, and then obtain the expected demand information of the entire service area at the time of restarting driving of the vehicle scheduled to be rested (S430 and S450).

After the service area of the vehicle scheduled to be rested is set, the resting place allocation module 130 may extract expected demand information of a plurality of candidate resting places within the service area from expected demand information of the entire service area (S470).

The resting place allocation module 130 may be configured to determine the allocation cost for each of a plurality of candidate resting places within the service area, using an allocation cost function defined by two factors, the moving distance from the current location of the vehicle scheduled to be rested to the corresponding candidate resting place and the expected demand information of the corresponding candidate resting place for each of a plurality of candidate resting places within the service area (S480). The allocation cost function may be defined as in Equation 1.

$$F ( j ) = X \times α + Y \times β \qquad ( Equation 1 )$$

Here, j may denote each candidate resting place, X may denote a moving distance from the current location of the vehicle to be rested to the corresponding candidate resting place, and may be expressed as a value between 0 and 1. Here, the current location may mean a location of the get-off place where the last passenger will get off if the last passenger is on board. X may include a smaller value as the moving distance from the current location of the vehicle to be rested to the corresponding candidate resting place increases. For example, assuming that there are 10 candidate resting places within the service area, the moving distance from the current location of the vehicle to be rested to the most distant candidate resting place among the 10 candidate resting places may be set to the minimum value (e.g., 0.1) among values between 0 and 1, and the moving distance from the current location of the vehicle scheduled to be rested to the closest candidate resting place among the 10 candidate resting places may be set to the maximum value (e.g., 0.9) among values between 0 and 1. Y may represent expected demand information of the candidate resting place, and may be expressed as a value between 0 and 1. Y may include a larger value as the expected demand for the candidate resting place increases. For example, assuming that there are 10 candidate resting places within the service area, the expected demand information of the candidate resting place with the highest demand among the 10 candidate resting places may be set to the maximum value (e.g., 0.9) among values between 0 and 1, and the expected demand information of the candidate resting place with the lowest demand among 10 candidate resting places may be set to a minimum value (e.g., 0.1) among values between 0 and 1. Meanwhile, the expression method of X and Y may be not limited thereto.

In Equation 1, α is a weight applied to the moving distance, β is a weight applied to the expected demand information, and α+B=1. At the instant time, α and β may be changed according to information on the length of the resting place of the vehicle scheduled to be rested.

The resting place allocation module 130 may be configured to determine one of the plurality of candidate resting places as a target resting place based on the allocation cost determined for each of the plurality of candidate resting places in the service area (S490), and allocate the target resting place to a vehicle scheduled to be rested. The resting place allocation module 130 may be configured to determine a candidate resting place having the largest allocation cost among the allocation cost determined for each of a plurality of candidate resting places within the service area as the target resting place.

The resting place allocation module 130 may transmit information on the target resting place to the vehicle terminal of the vehicle scheduled to be rested through the communication module 140 (S500).

On the other hand, the resting place allocation module 130 may set values of α and β of the allocation cost function according to the information on the rest time length of the vehicle to be rested prior to determining the allocation cost for each of the candidate resting places.

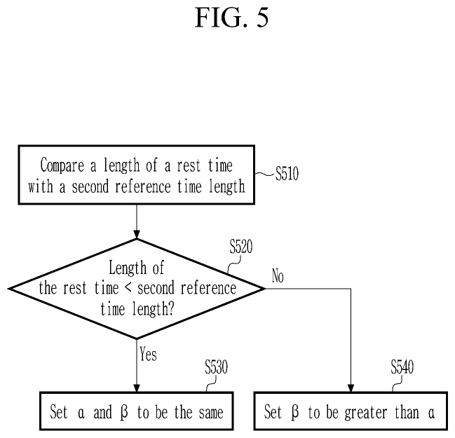

FIG. 5 is a flowchart illustrating a method of setting a weight value applied to an allocation cost function according to an exemplary embodiment of the present disclosure.

Referring to FIG. 5, the resting place allocation module 130 may compare the length of the rest time length with a second reference time length (S510). For example, the second reference time length may be set to 1 hour or may be set different from that.

If the rest time length of the vehicle scheduled to be rested is shorter than the second reference time length (S520), the resting place allocation module 130 may set the values of α and β to be the same (S530). That is, if the rest time length of the vehicle scheduled to be rested is shorter than the second reference time length (S520), the resting place allocation module 130 may set equal weights to each of the moving distance factor and the expected demand information factor. Alternatively, if the rest time length of the vehicle scheduled to be rested is shorter than the second reference time length (S520), the resting place allocation module 130 may set α to be greater than β. In the instant case, α applied to the first resting place allocation method may be greater than α applied to the second resting place allocation method.

Furthermore, if the rest time length of the vehicle scheduled to be rested is equal to or longer than the second reference time length (S520), the resting place allocation module 130 may set β to be greater than α (S540).

That is, if the rest time length of the vehicle scheduled to be rested is equal to or longer than the second reference time length, the resting place allocation module 130 may set a weight applied to the expected demand information factor to be greater than a weight applied to the moving distance factor. For example, α may be set to 0.3 and β may be set to 0.7. In the present way, if the value of β is set greater than α, the probability of allocating the vehicle to be rested may be increased to a resting place where expected demand is higher at the time of restarting driving the vehicle to be rested than to a resting place closer to the current location of the vehicle to be rested.

Meanwhile, in determining the resting place of the vehicle scheduled to be rested, the resting place allocation module 130 may additionally consider a driver's preference factor in addition to the moving distance factor and the expected demand information factor. If the driver's preference factor is added, the allocation cost function may be defined as in Equation 2.

$$F ( j ) = X \times α + Y \times β + Z \times δ \qquad ( Equation 2 )$$

Here, Z represents the driver's preference and may be expressed as a value between 0 and 1 according to the driver's preference priority. Z may include a larger value as the priority is higher. δ is a weight applied to the driver's preference, and α+β+δ=1. For example, if α=B=0 and δ=1, a candidate resting place with the highest priority exemplary by the driver may be determined as a target resting place of the vehicle scheduled to be rested. The α, β, and δ may be arbitrarily set, may be arbitrarily changed, and may be set according to rest time length information of a vehicle scheduled to be rested.

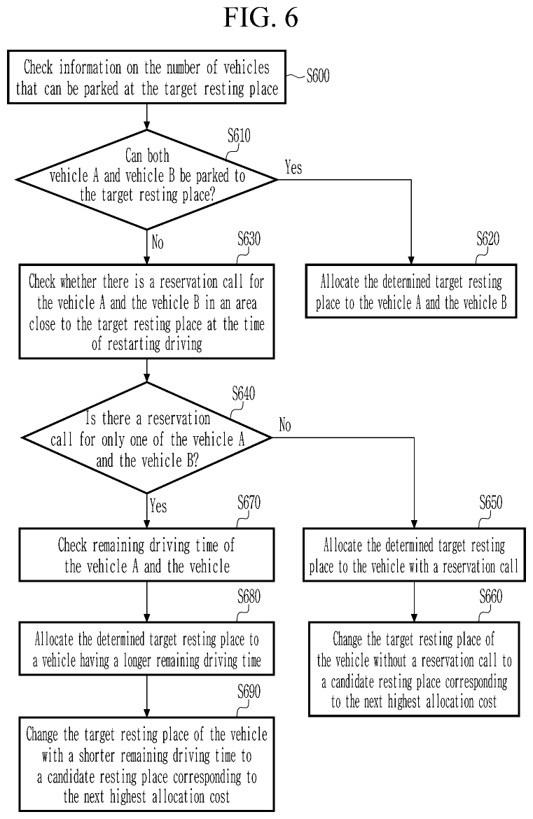

Furthermore, in a process of determining the target resting place of the vehicle to be rested according to the first resting place allocation method or the second resting place allocation method in the resting place allocation module 130, a case in which target resting places of two or more vehicles scheduled to be rested having rest times in the same time slot overlap may occur. If there are enough parking spots at the same target resting place, the same target resting place may be allocated to two or more vehicles scheduled to be rested, but if not, different target resting places may be allocated to two or more vehicles scheduled to be rested. A method of allocating different target resting places to two or more vehicles scheduled to be rested will be described in detail with reference to FIG. 6.

FIG. 6 is a flowchart illustrating an example of a solution if target resting place of two or more vehicles scheduled to be rested overlap. FIG. 6 may be additionally applied to both the first resting place allocation method and the second resting place allocation method, and for convenience, vehicle A and vehicle B scheduled to be rested are assumed and described.

Referring to FIG. 6, the resting place allocation module 130 may check information on the number of vehicles that can be parked at the target resting place if it is confirmed that the target resting places determined for the vehicle A and the vehicle B scheduled to be rested overlap each other (S600).

If it is possible to park in the target resting place for both the vehicle A and the vehicle B scheduled to be rested (S610), the resting place allocation module 130 may allocate the target resting place to the vehicle A and the vehicle B scheduled to be rested (S620).

The resting place allocation module 130, if it is impossible to park in the target resting place for both the vehicle A and the vehicle B scheduled to be rested, either the vehicle A or the vehicle B scheduled to be rested needs to be changed. The description below may be applied to a case where vehicle A and vehicle B scheduled to be rested cannot be allocated to the same target resting place.

If it is impossible to park in the target resting place for both vehicle A and vehicle B scheduled to be rested (S610), the resting place allocation module 130 may check whether there is a reservation call for the vehicle A and the vehicle B scheduled to be rested in an area close to the target resting place at the time of restarting the driving of the vehicle A and the vehicle B scheduled to be rested (S630).

If there is a reservation call for only one vehicle scheduled to be rested from among vehicle A and vehicle B scheduled to be rested (S640), the resting place allocation module 130 may allocate the determined target resting place to the vehicle scheduled to be rested with a reservation call (S650). In the case of a vehicle scheduled to be rested without a reservation call, the resting place allocation module 130 may change the target resting place to a candidate resting place corresponding to the next highest allocation cost among the allocation costs of the plurality of candidate resting places determined above (S660), and allocate the changed target resting place to the vehicle scheduled to be rested without a reservation call.

On the other hand, if both the vehicle A and the vehicle B scheduled to be rested have reservation calls, or if there is no reservation call for both the vehicle A and the vehicle B scheduled to be rested, the resting place allocation module 130 may check remaining driving time of the vehicle A and the vehicle B scheduled to be rested (S670).

The resting place allocation module 130 may allocate the determined target resting place to a vehicle scheduled to be rested, having a longer remaining driving time, among vehicle A and vehicle B scheduled to be rested (S680). In the case of a vehicle scheduled to be rested with a shorter remaining driving time, the resting place allocation module 130 may change the target resting place to a candidate resting place corresponding to the next highest allocation cost among the allocation costs of the plurality of candidate resting places determined above (S690), and allocate the changed target resting place to the vehicle scheduled to be rested with a shorter remaining driving time.

In FIG. 6, for convenience of description, vehicle A and vehicle B scheduled to be rested are assumed and described, but it is natural that there may be two or more vehicles scheduled to be rested, and in the instant case, only the number of vehicles scheduled to be rested that can be parked in the target resting place may be allocated based on whether there is a reservation call or remaining driving time, and the target resting place of the remaining vehicles scheduled to be rested may be changed.

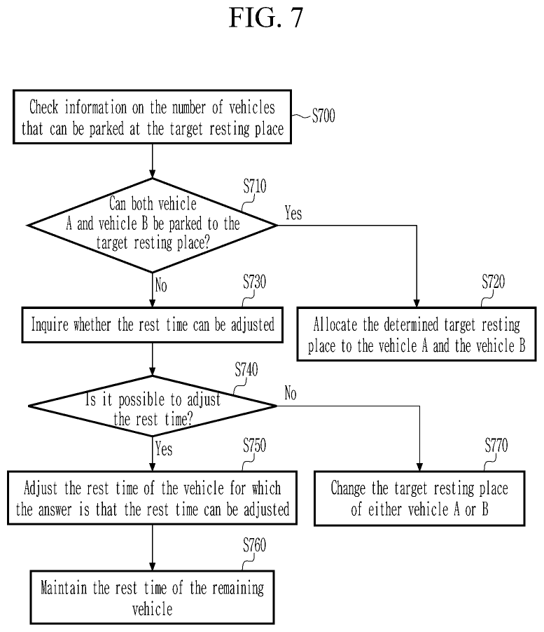

FIG. 7 is a flowchart illustrating another example of a solution if target resting place of two or more vehicles scheduled to be rested overlap.

Referring to FIG. 7, if it is confirmed that the target resting places of the vehicle A and the vehicle B scheduled to be rested overlap, the resting place allocation module 130 may check information on the number of vehicles that can be parked at the target resting place (S700).

If it is possible to park in the target resting place for both the vehicle A and the vehicle B scheduled to be rested (S710), the resting place allocation module 130 may allocate the target resting place to the vehicle A and the vehicle B scheduled to be rested (S720).

If it is impossible to park in the target resting place for both the vehicle A and the vehicle B scheduled to be rested (S720), the resting place allocation module 130 may inquire whether the rest time can be adjusted to at least one of the vehicle A and the vehicle B scheduled to be rested (S730), before changing the resting place of either the vehicle A or the vehicle B scheduled to be rested.

The resting place allocation module 130 may receive an answer to the inquiry from at least one of the vehicle A and the vehicle B scheduled to be rested.

If the received answer indicates that the rest time can be adjusted (S740), the resting place allocation module 130 may adjust the rest time of the vehicle scheduled to be rested for which the answer is that the rest time can be adjusted (S750), and maintain the rest time of the remaining vehicles scheduled to be rested as it is (S760).

Meanwhile, if it is impossible to adjust the rest time for both vehicle A and vehicle B to be rested, the resting place allocation module 130 may change the target resting place of either vehicle A or B to be rested through the method described in FIG. 6 (S770).

In the above, embodiments of determining target resting place of each vehicle based on the first resting place allocation method or the second resting place allocation method, allocating or changing a target resting place determined by considering whether there is a reservation call at the time of restarting driving and the remaining driving time for vehicles with overlapping target resting places has been described.

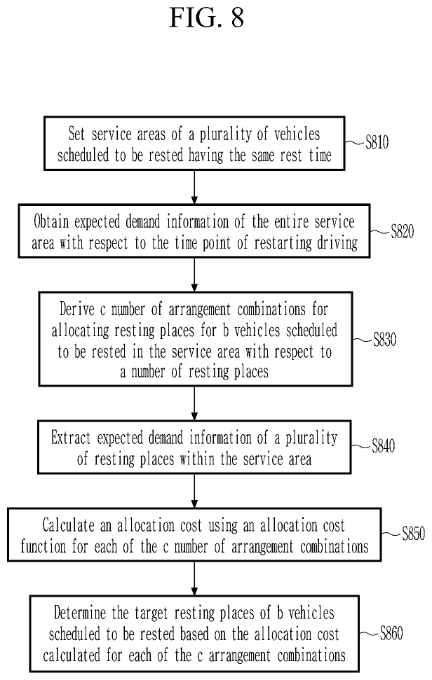

Meanwhile, target resting places for a plurality of vehicles scheduled to be rested having the same rest time may be simultaneously determined by use of all factors considered for determining the resting place for the plurality of vehicles scheduled to be rested having the same rest time. The present exemplary embodiment will be described in detail with reference to FIG. 8.

FIG. 8 is a flowchart illustrating a method of determining a resting place of the resting place allocation module shown in FIG. 2 according to an exemplary embodiment of the present disclosure.

The resting place allocation module 130 may set service areas of a plurality of vehicles scheduled to be rested having the same rest time (S810). The service area may be set as the sum of areas having a predetermined range centered on the locations of a plurality of vehicles scheduled to be rested having the same rest time. The location of the vehicle to be rested may mean the current location of the vehicle depending on whether or not the last passenger has boarded before the rest time, or may mean the location of a get-off place at which the last passenger will get off.

The resting place allocation module 130 may allocate a target resting place to each of the vehicles scheduled to be rested using an allocation cost function including a combination of at least two of the moving distance to the resting place, expected demand information of the resting place, driver's preference, whether there is a reservation call, and remaining driving time after the time of the restarting driving.

Specifically, the resting place allocation module 130 may set a time point after the predetermined rest time for the plurality of vehicles scheduled to be rested as the time point of restarting driving of the plurality of vehicles scheduled to be rested, and obtain expected demand information of the entire service area with respect to the time point of restarting the driving of the plurality of vehicles scheduled to be rested (S820).

The resting place allocation module 130 may derive c (here, c is natural number of 1 or more) number of arrangement combinations for allocating resting places for b (here, b is natural number of 1 or more) vehicles scheduled to be rested in the service area with respect to a (here, a is natural number of 1 or more) number of resting places located in the service area (S830).

The resting place allocation module 130 may receive resting place information including information about the number of vehicles that can be parked at each resting place, the number of vehicles currently parked at each resting place, and the location of each resting place through the communication module 140. For example, a resting place \textcircled{1} and a resting place \textcircled{2} may be located in the service area, and four arrangement combinations (B-\textcircled{1}, C-\textcircled{1}), (B-\textcircled{1}, C-\textcircled{2}), (B-\textcircled{2}, C-\textcircled{2}), and (B-\textcircled{2}, C-\textcircled{1}) may be derived for the vehicle B and the vehicle C to be rested. That is, it is possible to allocate a resting place to each vehicle scheduled to be parked while allowing overlap as much as the number of vehicles that can be parked in the resting place. However, if the number of vehicles that can be parked in the resting place \textcircled{1} and the resting place \textcircled{2} is smaller than the number of vehicles located in the current service area, the number of vehicles that can be allocated in the resting place \textcircled{1} and the resting place \textcircled{2} may be limited by the number of vehicles that can be parked. Specifically, if the number of vehicles that can be parked in any one of the resting place \textcircled{1} and the resting place \textcircled{1} is one, an arrangement combination in which the vehicle B and the vehicle C scheduled to be parked together at the resting place may be excluded.

Furthermore, if there is a vehicle currently parked at the resting place, the resting place allocation module 130 may be configured to generate an arrangement combination for allocating the remaining number of vehicles excluding the vehicles parked at the corresponding resting place from the number of vehicles available for parking at the corresponding resting place. For example, if the number of vehicles that can be parked in the resting place \textcircled{1} is two and one vehicle is parked, the number of vehicles that can be parked in the resting place \textcircled{1} is one, so in the arrangement combination of the above example, (B-\textcircled{1}, C-\textcircled{1}) may be excluded.

The resting place allocation module 130 may extract expected demand information of a plurality of resting places within the service area set in step S810 from the expected demand information of the entire service area (S840).

For each of the c number of arrangement combinations, the resting place allocation module 130 may be configured to determine an allocation cost using an allocation cost function including a combination of at least two of the moving distance to the resting place, expected demand information of the resting place at the time of the restarting driving, driver's preference, whether there is a reservation call, and remaining driving time after the time of the restarting driving (S850). The allocation cost function at the instant time may be expressed as in Equation 3.

$$F ( i ) = {\sum }_{n = 1}^{b} F ( n ) = X \times α + Y \times β + Z \times δ + V \times ω + W \times θ \qquad ( Equation 3 )$$

Here, i may represent each arrangement combination, and b may represent the number of combinations between the vehicle scheduled to be rested and the resting place included in the arrangement combination. F (n) may denote an allocation cost function of a combination between the n-th vehicle scheduled to be rested and the resting place included in the corresponding arrangement combination. X may represent a moving distance from the current location of the vehicle scheduled to be rested to the corresponding candidate resting place, and may be expressed as a value between 0 and 1. Here, the current location may mean a location of the get-off place where the last passenger will get off if the last passenger is on board. X may include a smaller value as the moving distance from the current location of the vehicle to be rested to the corresponding candidate resting place increases. Y may represent expected demand information of the candidate resting place, and may be expressed as a value between 0 and 1. Y may include a larger value as the expected demand for the resting place increases. Z may represent a driver's preference, and the driver's preference for a corresponding resting place may be represented by a value between 0 and 1. In the instant case, Z may include a larger value as the driver's preference is higher. V may indicate whether or not a reservation call is made of at the time of restarting the driving of the vehicle scheduled to be rested, and if there is a reservation call, it may be V=1, and if there is no reservation call, it may be V=0. W may represent the remaining driving time remaining from the time of restarting the driving of the vehicle scheduled to be rested, and may be expressed as a value between 0 and 1. Z may indicate a position of the corresponding remaining driving time within the range between a minimum value and a maximum value as a value for the remaining driving time, and may include a larger value as the remaining driving time increases. The α, β, δ, ω, and θ may be the weights applied to the moving distance to the resting place, expected demand information of the resting place, driver's preference, whether there is a reservation call, and remaining driving time after the time of the restarting driving, respectively. α, β, δ, ω, and θ may be arbitrarily set, may be arbitrarily changed, and may be set according to rest time length information of a vehicle scheduled to be rested.

That is, the resting place allocation module 130 may be configured to determine X, Y, Z, V, and W for each of the c arrangement combinations, and then determine allocation cost of each batch combination based on Equation 3 using X, Y, Z, V, and W.

The resting place allocation module 130 may be configured to determine the target resting places of b vehicles scheduled to be rested based on the allocation cost determined based on Equation 3 for each of the c arrangement combinations (S860). The resting place allocation module 130 may be configured to determine target resting place for b vehicles scheduled to be rested based on the arrangement combination having the largest allocation cost among the allocation costs determined based on Equation 3 for each of the c arrangement combinations.

For example, two resting places \textcircled{1}, and \textcircled{2} are located in the service area, and arrangement combinations (B-\textcircled{1}, C-\textcircled{1}), (B-\textcircled{1}, C-\textcircled{2}), (B-\textcircled{2}, C-\textcircled{2}), and (B-\textcircled{2}, C-\textcircled{1}) may be derived for the vehicle B and the vehicle C to be rested.

The resting place allocation module 130 may be configured to determine the value of [X×α+Y×β+Z×δ+V×ω+W×θ] for B-\textcircled{1}, and the value of [X×α+Y×β+Z×δ+V×ω+W×θ] for C-\textcircled{1}, and then determine the allocation cost for the arrangement combination of (B-\textcircled{1}, C-\textcircled{1}) by sum them. Next, the resting place allocation module 130 may be configured to determine the value of [X×α+Y×β+Z×δ+V×@+W×θ] for B-\textcircled{1}, and the value of [X×α+Y×β+Z×δ+V×@+W×θ] for C-\textcircled{2}, and then determine the allocation cost for the arrangement combination of (B-\textcircled{1}, C-\textcircled{2}) by sum them. In the present way, the resting place allocation module 130 may be configured to determine the allocation cost for the arrangement combination of (B-\textcircled{2} and C-\textcircled{2}), and is configured to determine the allocation cost for the arrangement combination of (B-\textcircled{2} and C-\textcircled{1}).

The resting place allocation module 130 may be configured to determine the resting place of each vehicle scheduled to be rested based on the arrangement combination having the largest allocation cost as a result of determining the allocation costs for four arrangement combinations (B-\textcircled{1}, C-\textcircled{1}), (B-\textcircled{1}, C-\textcircled{2}), (B-\textcircled{2}, C-\textcircled{2}), and (B-\textcircled{2}, C-\textcircled{1}). If the arrangement combination having the largest allocation cost is (B-\textcircled{1}, C-\textcircled{2}), the resting place allocation module 130 may be configured to determine resting place \textcircled{1} as the target resting place for vehicle B scheduled to be rested, and determine resting place \textcircled{2} as the target resting place for vehicle C scheduled to be rested.

In the present way, it is possible to reduce the time required to allocate resting places for a plurality of vehicles scheduled to be rested in the service area.

Meanwhile, as a result of determining the allocation cost based on Equation 3 for each of c arrangement combinations in resting place allocation module 130, two or more arrangement combinations having the highest allocation cost may appear. In the instant case, the resting places of the vehicles scheduled to be rested may overlap with each other. As in the method described with reference to FIG. 8, the resting place allocation module 130 may check whether or not the rest time is adjusted from any one of the vehicles scheduled to be rested, and may change the rest time of the vehicle scheduled to be rested for which the rest time can be adjusted.

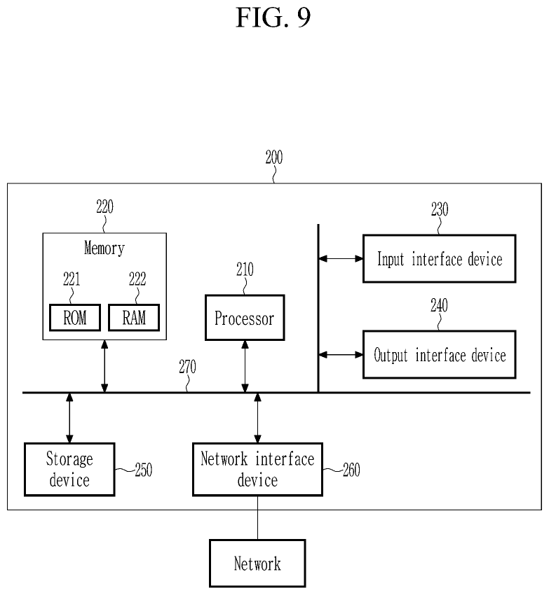

FIG. 9 is a diagram illustrating an apparatus for determining a vehicle resting place according to another exemplary embodiment of the present disclosure.

Referring to FIG. 9, the apparatus 200 for determining a vehicle resting place may represent a computing device in which the method for determining a vehicle resting place described above is implemented.

The apparatus 200 for determining a vehicle resting place may include at least one of processor 210, a memory 220, an input interface device 230, an output interface device 240, a storage device 250, and a network interface device 260. Each of the components may be connected by a common bus 270 to communicate with each other. Furthermore, each of the components may be connected through an individual interface or a separate bus centering on the processor 210 instead of the common bus 270.

The processor 210 may be implemented as various types such as an application processor (AP), a central processing unit (CPU), a graphics processing unit (GPU), etc., and may be any semiconductor device that executes a command stored in the memory 220 or the storage device 250. The processor 210 may execute program commands stored in at least one of the memory 220 and the storage device 250. The processor 210 may store program commands for implementing at least some functions of the monitoring module 110, the demand estimation module 120, and the resting place allocation module 130 in the memory 220 in the memory 220, and may control to perform the operation described with reference to FIGS. 2 to 6.

The memory 220 and the storage device 250 may include various types of volatile or non-volatile storage media. For example, the memory 220 may include a read-only memory (ROM) 221 and a random access memory (RAM) 222. The memory 220 may be located inside or outside the processor 210, and the memory 220 may be connected to the processor 210 through various known means.

The input interface device 230 may be configured to provide input data to processor 210.

The output interface device 240 may be configured to output data from processor 210.

The network interface device 260 may transmit or receive signals with an external device through a wired network or a wireless network.

According to the exemplary embodiment of the present disclosure, the resting place allocation method may be different based on the length of the rest time, and if the rest time is short, the resting place of the vehicle may be determined by applying a large weight to the moving distance element from the current vehicle location to the resting place, if the rest time is long, the resting place of the vehicle may be determined based on the moving distance from the current vehicle location to the resting place and expected demand information at the time of restart after the resting. Accordingly, moving time of the vehicle and cost may be reduced, and waiting time of passengers may be reduced.

At least some of the methods for determining a vehicle resting place according to exemplary embodiments of the present disclosure may be implemented as a program or software executed in a computing device, and the program or software may be stored in a computer-readable medium.

Furthermore, at least some of the method for determining a vehicle resting place according to an exemplary embodiment of the present disclosure may be implemented as hardware configured for being electrically connected to the computing device.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain predetermined principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for determining a resting place of a vehicle, the method comprising:
determining, by a processor, allocation costs, for a plurality of resting places for a vehicle scheduled to be rested, by reflecting at least one of a moving distance to a resting place, expected demand information of the resting place, a driver's preference, whether there is a reservation call at a time of restarting driving after a rest time, and remaining driving time after the time of restarting the driving; and
determining, by the processor, a target resting place of the vehicle scheduled to be rested based on the allocation costs for the plurality of resting places.

2. The method of claim 1, wherein the determining of the allocation costs includes:
setting a first weight, a second weight, a third weight, a fourth weight, and a fifth weight applied to the moving distance to the resting place, the expected demand information of the resting place, the driver's preference, the whether there is the reservation call at the time of restarting driving after the rest time, and the remaining driving time after the time of restarting the driving, respective to a length of the rest time of the vehicle scheduled to be rested.

3. The method of claim 2, wherein the determining of the allocation costs further includes:
converting the moving distance to the resting place, the expected demand information of the resting place, the driver's preference, the whether there is the reservation call at the time of restarting driving after the rest time, and the remaining driving time after the time of restarting the driving into values having a same unit.

4. The method of claim 2, wherein the setting includes setting the first weight in response that the length of the rest time is shorter than a predetermined first reference time length or setting a weight to be greater than the first weight in response that the rest time is equal to or longer than the first reference time length.

5. The method of claim 4, wherein the setting further includes setting the second weight to be greater than the first weight in response that the length of the rest time is equal to or longer than a second reference time length set to be longer than the first reference time length.

6. The method of claim 5, wherein the setting further includes setting the first weight equal to or greater than the second weight in response that the length of the rest time is shorter than the first reference time length.

7. The method of claim 2, wherein the setting further includes setting the first weight to 1 in response that the length of the rest time is shorter than a predetermined first reference time length.

8. The method of claim 1, wherein the determining of the allocation costs includes:
estimating expected demand information for each time slot for resting places of an entire service area with respect to timing of restarting the driving of the vehicle scheduled to be rested; and
obtaining expected demand information on the resting places in a service area of the vehicle scheduled to be rested from the expected demand information by time slot on the resting places in the entire service area.

9. The method of claim 1, further including:
in response that a target resting place of another vehicle scheduled to be rested whose rest time overlaps with the vehicle scheduled to be rested is a same as the target resting place of the vehicle scheduled to be rested, in a situation in which a resting place is not allocated within the service area or a resting has not started, changing the rest time of the vehicle scheduled to be rested, the rest time of which can be adjusted.

10. An apparatus for determining a resting place of a vehicle, the apparatus comprising:
a monitoring module for monitoring whether there is a vehicle scheduled to be rested for a rest time; and
a resting place allocation module for determining a target resting place of the vehicle scheduled to be rested by use of a first factor indicating a moving distance from a location of the vehicle scheduled to be rested to each candidate resting place and a second factor representing expected demand information of each candidate resting place at a time of restarting driving of the vehicle scheduled to be rested after the rest time, in response that the rest time is equal to or longer than a predetermined first reference time.

11. The apparatus of claim 10, further including:
a demand estimation module for estimating the expected demand information by time slot of an entire service area with respect to timing of the restarting driving of the vehicle scheduled to be rested.

12. The apparatus of claim 11, wherein the resting place allocation module is configured to set a first weight applied to the first factor and a second weight applied to the second factor.

13. The apparatus of claim 12, wherein the resting place allocation module is configured to set the first weight equal to or greater than the second weight in response that a length of the rest time is shorter than a predetermined second reference time length, and to set the second weight to be greater than the first weight in response that the length of rest time is longer than the second reference time length.

14. The apparatus of claim 11, wherein the resting place allocation module is configured to set a service area for the vehicle scheduled to be rested, and to extract expected demand information of a plurality of candidate resting places within the service area from expected demand information of the entire service area.

15. The apparatus of claim 10, wherein the resting place allocation module is configured to determine the target resting place further using a third factor representing driver's preference.

16. The apparatus of claim 10, wherein in response that there is a plurality of vehicles scheduled to be rested at a same determined target resting place, the resting place allocation module is configured to maintain or change the target resting place determined for the plurality of vehicles scheduled to be rested based on whether there is a reservation call at the time of restarting driving after the rest time and remaining driving time after the time of restarting the driving.

17. The apparatus of claim 10,
wherein the resting place allocation module is configured to determine the target resting place of the vehicle scheduled to be rested using the first factor and the second factor in response that a length of the rest time is shorter than a first reference time length, and
wherein a weight applied to the first factor in response that the length of the rest time is shorter than the first reference time length, is set higher than a weight applied to the first factor in response that the length of the rest time is greater than or equal to the first reference time length, or set to 1.

18. A method for determining a resting place of a vehicle, the method comprising:
deriving c number of arrangement combinations for allocating resting places b vehicles to be rested with overlapping rest times when a resting place is not allocated within a service area or a resting is not started for a number of resting places located in the service area;
determining an allocation cost using an allocation cost function including a combination of at least two of a moving distance to the resting place, expected demand information of the resting place, driver's preference, whether there is a reservation call at a time of the restarting driving, and remaining driving time after the time of the restarting driving, for each of the c number of arrangement combinations;
selecting one arrangement combination based on an allocation cost determined for each of the c arrangement combinations; and
determining resting places of the b vehicles scheduled to be rested according to the selected arrangement combination.

19. The method of claim 18, wherein the determining includes:
converting the moving distance between the vehicle scheduled to be rested and the resting place constituting each arrangement combination into a value between 0 and 1;
converting expected demand information of resting place constituting each arrangement combination into a value between 0 and 1;
converting a driver's preference for the resting place constituting each arrangement combination into a value between 0 and 1;
expressing as 0 or 1 whether there is a reservation call at a time of the restarting driving for the vehicle scheduled to be rested constituting each arrangement combination; and
converting remaining driving time after the time of the restarting driving for the vehicle scheduled to be rested constituting each arrangement combination into a value between 0 and 1.

20. The method of claim 18,
wherein the allocation cost function includes a first weight, a second weight, a third weight, a fourth weight, and a fifth weight applied the moving distance to the resting place, the expected demand information of the resting place, the driver's preference, the whether there is a reservation call at a time of the restarting driving, and the remaining driving time after the time of the restarting driving, respective, and
wherein at least some of the first to fifth weights are different from each other.

21. The method of claim 20, wherein the first weight, the second weight, the third weight, the fourth weight, and the fifth weight are determined based on a length of a rest time.

22. The method of claim 18, wherein the determining of the allocation costs includes:
in the selecting, in response that a same resting place is allocated to different vehicles scheduled to be rested by two or more arrangement combinations having a highest allocation cost, checking whether the rest time is adjusted from at least one vehicle scheduled to be rested; and
changing a rest time of a vehicle scheduled to be rested for which the rest time can be adjusted.
